(19) United States
(12) Patent Application Publication
(10) Pub. No.: US 2025/0004514 A1
(43) Pub. Date: Jan. 2, 2025

(54) Adjustable Thermal Management

(71) Applicants: Advanced Micro Devices, Inc, Santa Clara, CA (US); ATI Technologies ULC, Markham (CA)

(72) Inventors: Amitabh Mehra, Fort Collins, CO (US); William Robert Alverson, Del Valle, TX (US); Jerry Anton Ahrens, Sister Bay, WI (US); Grant Evan Ley, Eden, UT (US); Joshua Taylor Knight, Georgetown, TX (US); Anil Harwani, Austin, TX (US); Adam Neil Calder Clark, Victoria (CA)

(21) Appl. No.: 18/217,390

(22) Filed: Jun. 30, 2023

(51) Int. Cl. G06F 1/20; G01K 13/00

(52) U.S. Cl. CPC G06F 1/206; G01K 13/00; G01K 2213/00

(57) ABSTRACT

Adjustable thermal management is described. Input to adjust one or more parameters for controlling thermal conditions of a component is received. Temperature measurements of a component are obtained from two or more sensors of the component. A temperature of a thermal hotspot of the component is estimated based on the temperature measurements obtained from the two or more sensors of the component and using the adjusted parameters. Operation of the component is adjusted based on the estimated temperature of the thermal hotspot.

### BACKGROUND

Typically, computing systems have a discreet number of sensors (e.g., thermal sensors) to sense one or more conditions of portions of a computing system, e.g., of one or more components of the computing system. In scenarios where the sensors are thermal sensors that sense temperature of respective portions of the computing system, the system may use the sensed temperatures to control operation of the computing system.

### BRIEF DESCRIPTION OF THE DRAWINGS

FIG. 1 is a block diagram of a non-limiting example system having a memory and a controller operable to implement adjustable thermal management.

FIG. 2 is a block diagram of a non-limiting example in which a thermal hotspot of a component corresponds to a different location of the component from locations of sensors.

FIG. 3 depicts a non-limiting example of a user interface in one or more implementations.

FIG. 4 depicts a non-limiting example of layers that are displayable as part of a visualization for a component in a user interface for adjustable thermal management.

FIG. 5 depicts a non-limiting example of a visualization of a component that changes based on a prediction associated with adjusting one or more parameters for thermal management.

FIG. 6 depicts a non-limiting example of a visualization of a component that changes based on a prediction associated with executing a different workload and managing power using adjustable parameters for thermal management.

FIG. 7 depicts a procedure in an example implementation of adjustable thermal management.

### DETAILED DESCRIPTION

### Overview

Typically, computing systems have a discreet number of sensors (e.g., thermal sensors) to sense one or more current conditions of portions of a computing system, e.g., of one or more components of the computing system. In scenarios where the sensors are thermal sensors that sense the temperature of respective portions of the computing system, however, there may be a thermal hotspot that is not directly adjacent to a sensor and thus its actual temperature is not accurately reflected in the temperatures produced by the sensors. By way of example, this occurs in scenarios where the thermal hotspot is located at a different portion of the computing system from where the thermal sensors are disposed. Thus, in conventional approaches, system managers determine operating parameters (e.g., voltage and frequency) using a highest temperature measured by the sensors, which often does not correspond to the actual hottest portion of the computing system.

Due to localized hotspotting effects, where components' actual hotspots are at locations different from where sensors are disposed in the system thus causing the actual temperatures of those hotspots not to be recorded or adequately reflected in the data, conventional approaches rely on inherently erroneous instantaneous peak temperature data. In some cases, conventional approaches add a guardband, e.g., to voltage curves, to account for this error. By adding a guardband that is too large, though, conventional techniques fail to optimize performance and/or efficiency of the systems. Additionally, by adding a guardband that is insufficient to account for the actual temperature of the thermal hotspot, e.g., too small for the addition of the guardband needed to cover the actual highest temperature being experienced, conventional approaches can cause loss of stability for one or more components of the system and/or degradation of components due to the sensors not detecting the actual temperature peaks that components are experiencing.

To solve these problems, adjustable thermal management is described. In contrast to conventional approaches, a system manager receives data produced by a plurality of sensors over time (e.g., temperatures) and logs this data. The system manager estimates a location and/or temperature of one or more thermal hotspots of a component based on the data produced by the sensors. The system manager is further configured to adjust operation of one or more components of the system dynamically, such as by communicating a change signal to adjust a frequency, voltage, and/or timings at which components of the system operate. Notably, the system manager adjusts such operation based, in part, on conditions detected by the sensors (e.g., temperature) and based on one or more adjustable parameters.

For example, the system manager uses one or more parameters, as adjusted at the time, to estimate the location and/or temperature of one or more thermal hotspots. In contrast to conventional techniques where an algorithm that controls a system response to changing conditions is static, the described techniques enable the thermal management algorithm to be adjusted by modifying one or more parameters, such as terms of an underlying thermal management algorithm used by a system manager to respond to detected thermal events, weights, degree (e.g., linear, quadratic, etc.) of the algorithm, constants, values, and so forth.

In one or more implementations, the parameters are adjustable by user input received via a user interface. For example, the system manager can expose a user interface that is configured to receive input specifying adjustments to the one or more parameters, e.g., of the thermal management algorithm. The parameters are then adjusted based on the user input received via the user interface, such that the system manager uses the adjusted parameters to respond to detected events, e.g., by communicating one or more change signals.

In one or more scenarios, therefore, a first set of parameters is used to respond to detected conditions (e.g., thermal events) during a first interval of time and after an input to adjust the parameters, a second set of parameters is used to respond to conditions at a second, subsequent interval of time, where the second set of parameters includes at least one different parameter from the first set of parameters. Due to the one or more different parameters, the system manager is configured to generate a different response to one or more estimations of phenomena and/or their locations during the first time period than during the second time period.

Notably, the temperature and/or a location of a hotspot determined using the multiple sensors and the described parameters is more accurate than conventional techniques which throttle operation based on a temperature of a hottest sensor. More accurate determination of system and/or component temperatures is particularly advantageous for overclocking, as temperature impacts whether higher performance of the system is achievable.

Moreover, at least one example advantage of the described techniques is that they can reduce the number of sensors which are incorporated in computing systems. In order for conventional approaches, which assume that a hottest measured temperature corresponds to the hottest temperature of the system, to be more accurate, such techniques would need to increase a density of sensors throughout the system. However, sensors consume area or volume of the system and adding more of them takes up more area or volume, resulting in physically larger systems (e.g., systems on chip), which can be more expensive than designs with fewer sensors. By way of contrast, the described techniques achieve greater accuracy with fewer sensors than conventional approaches. Additionally, some components like arithmetic logic units, are not configurable to include sensors due to the size of the sensors and the placement sensitive density of the logic in these logic units. Due to this, conventional approaches that rely on a highest measured temperature from a sensor are not suitable for determining the hottest portion of a system that includes such components.

In some aspects, the techniques described herein relate to a system including: a processor, a first thermal sensor positioned at a first portion of the processor, a second thermal sensor positioned at a second portion of the processor, and a system manager, the system manager configured to: obtain a first temperature measurement from the first thermal sensor and a second temperature measurement from the second thermal sensor, estimate, using one or more adjustable parameters, a temperature of a thermal hotspot on the processor based on the first temperature measurement and the second temperature measurement, and adjust one or more settings of the processor based on the estimated temperature of the thermal hotspot.

In some aspects, the techniques described herein relate to a system, wherein the system manager is further configured to estimate a location of the thermal hotspot.

In some aspects, the techniques described herein relate to a system, wherein the estimated temperature of the thermal hotspot is higher than the first temperature measurement and the second temperature measurement.

In some aspects, the techniques described herein relate to a system, wherein the thermal hotspot is located at a different portion of the processor from where the first thermal sensor and the second thermal sensor are disposed.

In some aspects, the techniques described herein relate to a system, wherein the system manager is further configured to: expose a user interface for adjusting the one or more adjustable parameters used to estimate the thermal hotspot, receive, via the user interface, user input to adjust the one or more adjustable parameters, and save the adjusted parameters for subsequent use to estimate temperatures of thermal hotspots on the processor.

In some aspects, the techniques described herein relate to a system, wherein the one or more adjustable parameters include at least one of a term, weight, degree, constant, or value of a thermal management algorithm.

In some aspects, the techniques described herein relate to a system, wherein the one or more adjustable parameters are adjustable by: adding or removing one or more gain terms from the parameters, adjusting one or more deltas to maintain between the first thermal sensor and the second thermal sensor, adjusting a slope associated with estimating temperatures of thermal hotspot on the processor based on temperature measurements produced by the first thermal sensor and the second thermal sensor, adjusting a presence or absence of one or more filters in the parameters, or adjusting parameters of the one or more filters.

In some aspects, the techniques described herein relate to a system, wherein the system manager is further configured to: receive, from an application, input to adjust the one or more adjustable parameters, and save the adjusted parameters for subsequent use to estimate temperatures of thermal hotspots on the processor.

In some aspects, the techniques described herein relate to a system, wherein the system manager is configured to estimate the temperature of the thermal hotspot at a first interval of time using a first set of parameters, and wherein the system manager is configured to estimate an additional temperature of the thermal hotspot at a second interval of time using a second set of parameters, the second set of parameters having been adjusted from the first set of parameters.

In some aspects, the techniques described herein relate to a system, wherein the system manager is configured to predict the temperature of the thermal hotspot by: determining a temperature delta between the first temperature measurement and the second temperature measurement, determining a slope of the temperature delta, and predicting the temperature of the thermal hotspot based on the slope of the temperature delta.

In some aspects, the techniques described herein relate to a method including: receiving input to adjust one or more parameters used to control thermal conditions of a component, obtaining temperature measurements of the component from two or more sensors of the component, estimating a temperature of a thermal hotspot of the component based on the temperature measurements obtained from the two or more sensors of the component and using the adjusted parameters, and adjusting operation of the component based on the estimated temperature of the thermal hotspot.

In some aspects, the techniques described herein relate to a method, wherein the receiving input further includes: exposing a user interface for adjusting the one or more parameters, and receiving, via the user interface, the input to adjust the one or more parameters.

In some aspects, the techniques described herein relate to a method, wherein the one or more parameters include at least one of a term, weight, degree, constant, or value of a thermal management algorithm.

In some aspects, the techniques described herein relate to a method, wherein the adjusting includes one or more of: adding or removing one or more gain terms from the parameters, adjusting one or more deltas to maintain between the two or more sensors of the component, adjusting a slope associated with estimating temperatures of thermal hotspots of the component based on temperature measurements produced by the two or more sensors, adjusting a presence or absence of one or more filters in the parameters, or adjusting parameters of the one or more filters.

In some aspects, the techniques described herein relate to a method, wherein the receiving input further includes receiving, from an application, the input to adjust the one or more parameters.

In some aspects, the techniques described herein relate to a method, wherein the estimating further includes estimating the temperature of the thermal hotspot at a first interval of time using a first set of parameters.

In some aspects, the techniques described herein relate to a method, further including estimating an additional temperature of the thermal hotspot at a second interval of time using a second set of parameters, wherein the second set of parameters is different from the first set of parameters.

In some aspects, the techniques described herein relate to a method, wherein the thermal hotspot is located at a different portion of the component from where the two or more sensors are disposed.

In some aspects, the techniques described herein relate to a method, wherein the estimated temperature of the thermal hotspot is higher than the obtained temperature measurements.

In some aspects, the techniques described herein relate to a device including: a stacked memory having a plurality of memory dies, and a system manager configured to: obtain temperature measurements from thermal sensors associated with different memory dies of the stacked memory, predict a hotspot of the stacked memory based on a difference between the temperature measurements from the thermal sensors using one or more adjustable parameters, and adjust one or more settings of the stacked memory based on the predicted hotspot.

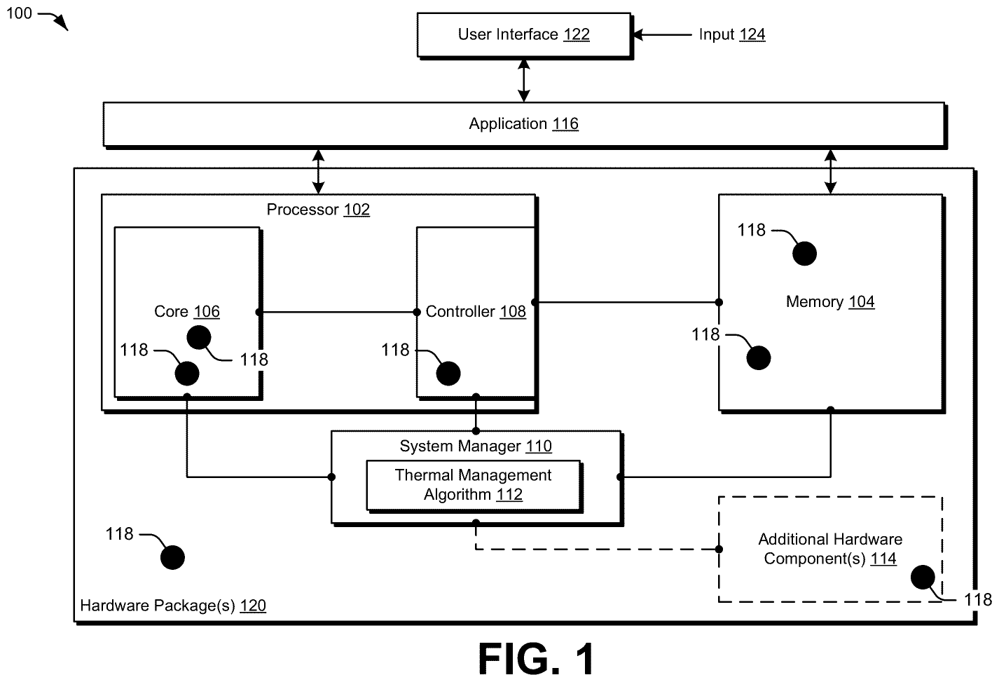

FIG. 1 is a block diagram of a non-limiting example system 100 having a memory and a controller operable to implement adjustable thermal management. In this example, the system 100 includes processor 102 and memory 104. In at least one implementation, the processor 102 includes a core 106 and a controller 108. The system 100 also includes a system manager 110, which controls the power provided to one or more components of the system 100 according to a thermal management algorithm 112. In the illustrated example, the system 100 is further depicted with additional hardware component(s) 114 (e.g., cache, secondary storage, semiconductor intellectual property (IP) core, etc.), which represents that, in variations, the system 100 includes one or more optional, additional hardware component(s) 114.

The processor 102, the memory 104, and optionally the additional hardware component(s) 114 are operable to implement one or more applications 116, including, for instance, a thermal management application that presents information about and/or supports dynamic adjustment of the thermal management algorithm 112 to control power supplied to various hardware of the system 100 based on one or more conditions detected by sensors 118 disposed in the system 100.

In this example, the above-described components (e.g., the processor 102, the memory 104, the additional hardware component(s) 114, etc.) are depicted included in a hardware package 120. An example of the hardware package 120 includes but is not limited to a printed circuit board (PCB), such as a motherboard and/or a system-on-chip (SoC). In at least one variation, components of the system 100 are implemented using more than one hardware package, such using more than one printed circuit board (PCB). It is to be appreciated also, that in at least one variation, the system 100 does not include one or more of the depicted components and/or includes different components without departing from the spirit or scope of the described techniques.

In accordance with the described techniques, the processor 102 and the memory 104 are coupled to one another via a wired or wireless connection. The core 106 and the controller 108 are also depicted coupled to one another via one or more wired or wireless connections. The other components of the system 100 are connectable via wired and/or wireless connections. Example wired connections include, but are not limited to, memory channels, buses (e.g., a data bus), interconnects, through silicon vias, traces, and planes. Other example connections include optical connections, fiber optic connections, and/or connections or links based on quantum entanglement.

Examples of devices or apparatuses in which the system 100 is implemented include, but are not limited to, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer, and other computing devices or systems.

The processor 102 is an electronic circuit that performs various operations on and/or using data in the memory 104. Examples of the processor 102 include, but are not limited to, a central processing unit (CPU), a graphics processing unit (GPU), a field programmable gate array (FPGA), an accelerator, an accelerated processing unit (APU), and a digital signal processor (DSP), to name a few. The core 106 is a processing unit that reads and executes instructions (e.g., of a program), examples of which include to add, to move data, and to branch. Although one core 106 is depicted in the illustrated example, in variations, the processor 102 includes more than one core 106, e.g., the processor 102 is a multi-core processor.

The memory 104 is a device or system that is used to store information, such as for immediate use in a device, e.g., by the processor 102 or by an in-memory processor (not shown), which is referred to as a processing-in-memory component or PIM component. In one or more implementations, the memory 104 corresponds to semiconductor memory where data is stored within memory cells on one or more integrated circuits. In at least one example, the memory 104 corresponds to or includes volatile memory, examples of which include random-access memory (RAM), dynamic random-access memory (DRAM), synchronous dynamic random-access memory (SDRAM), static random-access memory (SRAM), and memristors.

The memory 104 is packaged or configured in any of a variety of different manners. Examples of such packaging or configuring include a dual in-line memory module (DIMM), a small outline DIMM (SO-DIMM), a registered DIMM (RDIMM), a non-volatile DIMM (NVDIMM), a ball grid array (BGA) memory permanently attached to (e.g., soldered to) the hardware package 120 (or other printed circuit board), and so forth.

Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the memory 104 is configured as or includes a SO-DIMM or an RDIMM according to one of the above-mentioned standards, e.g., DDR, DDR2, DDR3, DDR4, and DDR5.

Alternatively or in addition, the memory 104 corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto resistive random-access memory (MRAM). The memory 104 is configurable in a variety of ways capable of supporting thermal management using an adjustable thermal management algorithm and/or receiving power managed using such an adjustable algorithm.

Further examples of memory configurations include low-power double data rate (LPDDR), also known as LPDDR SDRAM, which is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5). It is to be appreciated that the memory 104 is configurable in a variety of ways without departing from the spirit or scope of the described techniques.

The controller 108 is a digital circuit that manages the flow of data to and from the memory 104. By way of example, the controller 108 includes logic to read and write to the memory 104 and interface with the core 106, and in variations to interface with multiple cores and/or a processing-in-memory component (not shown). For instance, the controller 108 receives instructions from the core 106 which involve accessing the memory 104, and the controller 108 provides data from the memory 104 to the core 106, e.g., for processing by the core 106. In one or more implementations, the controller 108 is communicatively and/or topologically located between the core 106 and the memory 104, and the controller 108 interfaces with both the core 106 and the memory 104. In one or more implementations, the controller 108 is separate from the processor 102. Alternatively or additionally, the system 100 includes the controller 108 as part of the processor 102 and also includes at least one additional controller separate from the processor 102, e.g., a memory controller.

In one or more implementations, the system manager 110 includes or is otherwise configured to interface with one or more systems capable of updating operation of various components of the system 100, examples of such systems include but are not limited to an adaptive voltage scaling (AVS) system, an adaptive voltage frequency scaling (AVFS) system, and a dynamic voltage frequency system (DVFS). For example, the system manager 110 uses such systems to adjust settings (e.g., voltage, frequency, timings, etc.) with which the various components of the system operate. In one or more implementations, the system manager 110 is configured as a microcontroller disposed on a die running firmware to perform a variety of the operations discussed above and below.

In accordance with the described techniques, for instance, the system manager 110 is configured to adjust operation of one or more components of the system dynamically, such as by communicating a change signal to adjust a frequency, voltage, and/or timings at which components of the system operate. Further, the system manager 110 adjusts such operation based, in part, on conditions detected by the sensors 118 (e.g., temperature) and based on the thermal management algorithm 112, namely, how the thermal management algorithm 112 is adjusted at a time corresponding to the detected conditions.

Although the system manager 110 is depicted separately from the processor 102 and the memory 104, in one or more implementations, the system manager 110 is included as part of the processor 102, the memory 104, or the additional hardware component(s) 114. Alternatively or additionally, one or more components of the system 100 includes a component manager (not shown), which performs one or more of the operations described above and below as being performed by the system manager 110. By way of example, and not limitation, the processor 102 and the memory 104 each include a component manager, operable to implement thermal management using a respective adjustable thermal management algorithm. Although a firmware implementation is discussed above, in one or more variations, the system manager 110 is implemented using hardware in addition to or rather than firmware. In one example, for instance, the system manager 110 is implemented using hardware in a core.

In accordance with the described techniques, the system 100 also includes a plurality of the sensors 118, e.g., a plurality of thermal sensors. Although the sensors are depicted as being integral with various components of the system 100, in one or more implementations, only a single component includes the plurality of sensors 118, e.g., the core 106 or the memory 104. Alternatively or additionally, any two or more components of the system 100 includes one or more sensors of the plurality of sensors 118. Certainly, the plurality of sensors 118 can be integrated throughout the system (or throughout an individual component) in a variety of ways without departing from the spirit or scope of the described techniques.

In conventional approaches, operation of components is managed based on a temperature associated with a “hottest” sensor, and the temperature obtained from this sensor is used as a basis for throttling voltage, frequency, and so on, of various components of the system. In operation, however, a portion of a computing system having a hottest temperature may not be at a location where a sensor, e.g., a thermal sensor, is positioned. Instead, the portion of the computing system having a hottest temperature may be at a location of the computing system some distance away from where one or more of the sensors are positioned. Due to this, conventional approaches often throttle operation of one or more computing system components based on an incorrect view of the hottest temperature, e.g., a temperature that is less than the actual hottest temperature of the computing system or less than the actual hottest temperature of a component of the computing system. This can lead to instability or damage of components during operation and/or degradation of system hardware over time.

In contrast to conventional approaches, in one or more implementations, the system manager 110 receives data produced by the plurality of sensors 118 over time (e.g., temperatures) and logs this data. The system manager 110 estimates a location and/or temperature of one or more thermal hotspots of a component and/or the system 100 based on the data produced by the sensors 118 over time and spatially. In one or more implementations, the system manager 110 uses the thermal management algorithm 112, as adjusted at the time, to estimate the location and/or temperature of one or more thermal hotspots. Additionally or alternatively, the system manager 110 responds to estimated locations and/or temperatures of thermal hotspots based on the thermal management algorithm 112, as adjusted at the time.

In at least one variation, the system manager 110 determines temperature deltas between two or more of the sensors 118 using one or more algorithms that account for temperature deltas, e.g., the thermal management algorithm 112 and/or a different, additional algorithm. For example, the system manager 110 determines a slope of a temperature delta (e.g., a difference) between at least two of the sensors 118. By way of example, two or more of the sensors 118 measure differences (e.g., in temperature) within a particular core, between different cores on a same piece of silicon, between different pieces of silicon within a package, e.g., a component with a stacked configuration such as Vcache and/or stacked DRAM. In at least one variation, the system 100 includes sensors 118 disposed between components, such as between different dies of a component having a stacked configuration.

In one or more implementations, the thermal management algorithm 112 and/or at least one additional, different algorithm is based on information obtained in pre-silicon analysis and/or information obtained in post-silicon thermal imaging/mapping. For example, those algorithms have parameters (e.g., terms) which account for the information obtained in pre-silicon analysis and/or in post-silicon thermal imaging/mapping. Alternatively or in addition, the thermal management algorithm 112 and/or the at least one other algorithm is based on building one or more models from such information to calculate (e.g., estimate) local temperature hotspots, given as input thermal sensor information from one or more of the sensors 118 disposed throughout the system 100. In at least one variation, the input thermal sensor information is static and corresponds to a point in time. In at least one additional variation, the input thermal sensor information corresponds to measurements from the sensors 118 over time, e.g., an interval of time. In other words, a history of measurements is maintained and/or account for by the thermal management algorithm 112 and/or another algorithm utilized by the system manager 110.

In one or more implementations, the information obtained during the analysis and/or during the thermal imaging/mapping is indicative of locations in the system 100 of various components, such as locations of various logic units in the system 100 that produce more heat than other portions of the system 100, e.g., data cache, scheduler, floating point, etc. As such, the algorithms account for the location of such components, which enables the location of a thermal hotspot to be predicted using the knowledge embedded in the algorithms of component locations. In one or more implementations, the system manager 110 also monitors activity (e.g., processing and/or localized power density) associated with one or more logical units, and uses this information when predicting a location and/or temperature of a thermal hotspot.

Based on one or more temperature differences (and/or a slope of them), for instance, the system manager 110 predicts a temperature of the actual hotspot and/or determines a correction, e.g., from a table and/or algorithmically. The system manager 110 adds the correction to at least one of the temperature measurements produced by one or more of the sensors 118 to produce a computationally corrected temperature. In scenarios where an algorithm predicts the hottest temperature, the output of the algorithm can be used as the computationally corrected temperature.

This computationally corrected temperature is then used as a basis for the system manager 110 to adjust operation of components according to the thermal management algorithm 112. By way of example, the system manager 110 computes one or more adjustments to make to operation of one or more components using the thermal management algorithm 112 and the computationally corrected temperature. Examples of such adjustments include, for instance, throttling one or more of voltage, frequency, timings, and so on, for one or more components of the system 100—the estimated temperature and location are used with the thermal management algorithm 112 rather than simply using the temperature produced by a sensor 118 (and a guardband).

In one or more implementations, the estimated phenomena (e.g., thermal hotspot temperature) and location of phenomena (e.g., thermal hotspot location) are expressed in a variety of ways, including but not limited to values indicative of conditions (e.g., temperature values) and location coordinates (e.g., x-, y-, z-coordinates applied to the system), topographical maps, and so forth. It is to be appreciated that in variations, estimates of phenomena and their locations are expressed and/or formatted in a variety of ways without departing from the spirit or scope of the described techniques. Further, the thermal management algorithm 112 is applicable to those estimates to determine which of one or more adjustments to make, if any, e.g., throttling one or more of voltage, frequency, timings, and so on, and by how much.

In contrast to conventional techniques where an algorithm that controls a system response to changing conditions is static, the described techniques enable the thermal management algorithm 112 to be adjusted, e.g., based on user input, by an application 116, based on a particular workload being performed, and so forth. The thermal management algorithm 112 is adjustable, for instance, by modifying one or more portions (e.g., parameters) of the algorithm, such as terms, weights, degree (e.g., linear, quadratic, etc.), constants, values, and so forth.

In at least one variation, the system manager 110 exposes one or more interfaces (e.g., an application programming interface (API) and/or a user interface) configured to receive input specifying adjustments to the algorithm (e.g., one or more parameters of the algorithm) and to cause the system manager 110 to adjust the algorithm according to the input. Examples of adjustments include, but are not limited to, adding or removing one or more gain terms, adjusting deltas (e.g., maximum temperature difference) to maintain between at least two sensors, adjusting a slope (e.g., linear, polynomial, etc.) associated with using the algorithm to estimate detected events (e.g., temperatures and/or locations of thermal hotspots) and/or to control a response to detected events, adjusting the presence or absence of one or more filters, adjusting parameters of the filters, adjusting an amount of history (e.g., of measurements) to store and use to determine system responses (e.g., a point in time versus a first interval of time versus a second, longer interval of time), and so forth. It is to be appreciated that in variations interfaces to the thermal management algorithm 112 enable the thermal management algorithm 112 to be adjusted in various ways without departing from the spirit or scope of the described techniques.

In one or more scenarios, therefore, the thermal management algorithm 112 is used with a first set of parameters during a first interval of time and after an input to adjust the thermal management algorithm 112, the thermal management algorithm 112 is used with a second set of parameters at a second, subsequent interval of time, where the second set of parameters includes at least one different parameter from the first set of parameters. Due to the one or more different parameters, the thermal management algorithm 112 is configured to generate a different response to one or more estimations of phenomena and/or their locations during the first time period than during the second time period.

As noted above, in variations, the thermal management algorithm 112 is adjustable based on user input and/or as specified by an application. By way of example, the illustrated example depicts user interface 122. In one or more variations, the user interface 122 is output by an application 116, such as a thermal management application. For example, the user interface 122 is displayed and or made accessible via a voice-based user interface. The user interface 122 is depicted receiving input 124 to adjust one or more parameters of the thermal management algorithm 112. For instance, the user interface 122 receives the input 124 (e.g., via one or more interactive interface elements) to adjust one or more of parameters, such as by adding or removing one or more gain terms, adjusting deltas, adjusting a slope associated with the algorithm (e.g., linear, polynomial, etc.), adjusting the presence or absence of one or more filters, adjusting parameters of the filters, adjusting an amount of history (e.g., of measurements) to store and use to determine system responses (e.g., a point in time versus a first interval of time versus a second, longer interval of time), and so forth. Thus, in one or more variations, the input 124 to adjust the thermal management algorithm 112 is user input received via the user interface 122.

Alternatively or additionally, the system 100 supports receiving input 124 from one or more application 116 to adjust the thermal management algorithm 112. In one or more variations, for instance, an application 116 includes configuration settings which specify parameters to which to adjust the thermal management algorithm 112 for optimal performance of the application 116. Alternatively or in addition, an application 116 includes configuration settings which specify parameters to which to adjust the thermal management algorithm 112 for optimal performance of particular workloads, e.g., on a workload-by-workload basis and/or on a type of workload basis. In one example, for instance, a computer game application includes settings that specify a first set of parameters to which to adjust the thermal management algorithm 112 for graphics rendering and a second set of parameters at which to adjust the thermal management algorithm 112 for game physics. In scenarios where an application 116 provides the input 124 to adjust the thermal management algorithm 112, for example, the application 116 provides an instruction to the processor 102 to adjust the thermal management algorithm 112.

Although not depicted in the illustrated example, in one or more variations, the system manager 110 or some other component of the system 100 stores or otherwise maintains one or more profiles for adjusting the thermal management algorithm 112. By way of example, each profile corresponds to one or more workloads and includes an indication of respective parameters to which to adjust the thermal management algorithm 112 when those one or more workloads are executed or otherwise performed by the system 100. Thus, when the one or more workloads are detected, the system manager 110 adjusts the thermal management algorithm 112 automatically to have the respective parameters specified in the profile. In one or more implementations, such profiles are created based on user input, based on input from one or more of the application 116, obtained from another source (e.g., downloadable from a manufacturer of at least one portion of the system or a provider of an operating system). In at least one variation, the processor 102, the memory 104, and optionally the additional hardware component(s) 114 are operable to implement an operating system (not shown), which is capable of providing input 124 to adjust the thermal management algorithm 112, e.g., in a similar manner as one or more of the applications 116.

Notably, a temperature and location of a hotspot determined using the thermal management algorithm 112 are more accurate than conventional techniques which throttle operation based on a temperature of a hottest sensor. More accurate determination of system and/or component temperatures is particularly advantageous for overclocking, as temperature impacts whether higher performance of the system 100 is achievable.

In one or more implementations, the thermal management algorithm 112 is run by the system manager 110 to determine temperature deltas (e.g., between sensors 118) and use them to adjust a voltage and/or frequency operation point (or another aspect of operating components) to keep the temperature deltas (e.g., between the sensors 118) within a threshold difference. By maintaining a delta between sensors 118 within a range, the system manager 110 increases the accuracy of predicting the temperature of actual hotspot locations and temperatures, e.g., using extrapolation. This is because when deltas between the sensors 118 are too large, extrapolation error is introduced into the predictions, which can cause inaccurate predictions. Thus, in one or more implementations, the system manager 110 monitors the deltas according to the thermal management algorithm 112 and, when the deltas satisfy a threshold difference (e.g., are larger than or equal to the difference), the system manager 110 performs one or more actions (e.g., adjusts voltage, frequency, timings, etc.) as specified by the thermal management algorithm 112 to cause the deltas to return within the threshold. In other words, through iterations of monitoring deltas and performing actions to adjust operational aspects of the components, the system manager 110 is configured to control the deltas (e.g., the temperature deltas) between the sensors 118.

Additionally or alternatively, the system manager 110 logs the data produced by the sensors over time to generate a model of temperature changes throughout the system 100 (or components) over time, which allows for filtering and additional adjustments. In one or more implementations, an amount of data (e.g., an interval of time) leveraged by the thermal management algorithm 112 is a parameter of the algorithm that is adjustable, e.g., based on user input, input from an application, from a profile, and so on. By logging this data over time and generating such a model, for instance, the system manager 110 determines how different workloads affect temperatures of portions of the system 100 over time, such that the system manager 110 can subsequently “prepare” one or more components of the system 100 (e.g., throttle voltage, frequency, timings, etc.) preemptively to handle a given workload.

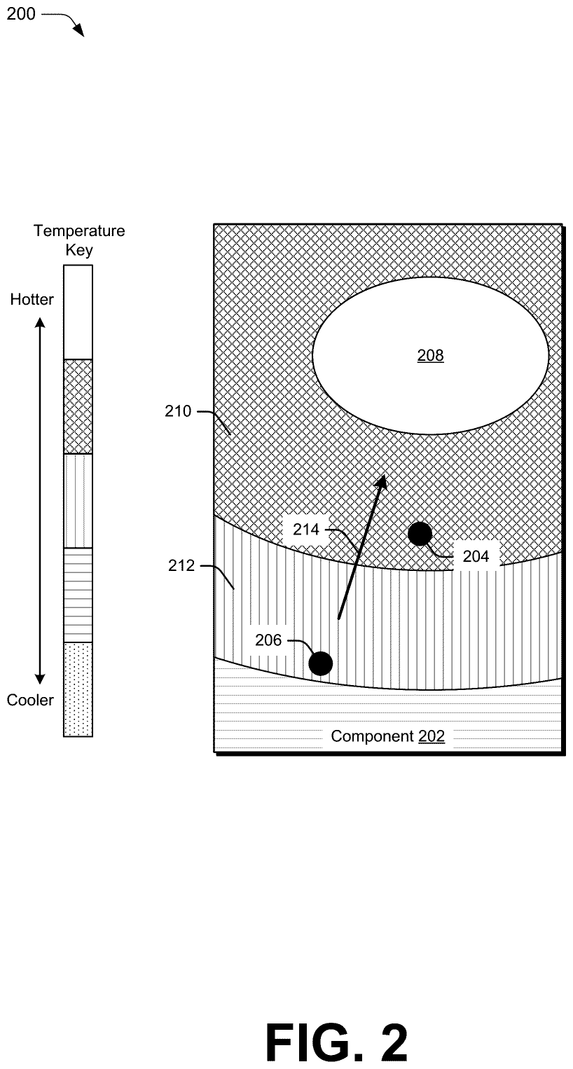

FIG. 2 is a block diagram of a non-limiting example 200 in which a thermal hotspot of a component corresponds to a different location of the component from locations of sensors.

The illustrated example 200 includes component 202, which corresponds to one or more components of the system 100. In this example 200 the component 202 includes at least a first sensor 204 and a second sensor 206, which are examples of the sensors 118. The example 200 also depicts a thermal hotspot 208 of the component 202, e.g., the actual hottest portion of the component 202. In this example 200, though, neither the first sensor 204 nor the second sensor 206 is located at the thermal hotspot 208, which corresponds to a first temperature. Instead, the first sensor 204 is located at a portion 210 of the component 202 that corresponds to a second temperature, and the second sensor 206 is located at a portion 212 of the component 202 that corresponds to a third temperature. In one or more scenarios, the second temperature at the first portion 210 is less than the first temperature at the thermal hotspot 208, and the third temperature at the second portion 212 is less than the second temperature. This example 200 depicts a scenario where the actual temperature of the component 202 increases in the direction of arrow 214.

In accordance with the described techniques, the system manager 110 obtains data (e.g., temperature measurements) from the first sensor 204 and the second sensor 206 and logs this data. The system manager 110 also determines a difference between the data produced by the first sensor 204 and the data produced by the second sensor 206, e.g., a temperature difference. For instance, the system manager 110 determines a difference between the data produced by the first sensor 204 and the second sensor 206 at substantially a same time, e.g., the system manager 110 computes the difference for correspondences in the data. In one or more variations, the system manager 110 determines the difference according to the thermal management algorithm 112, e.g., by executing the thermal management algorithm 112 and/or using logic corresponding to the thermal management algorithm 112.

In one or more implementations, the system manager 110 computes a difference in corresponding phenomena or conditions (e.g., temperatures) measured (e.g., at a substantially same time) by the first sensor 204 and the second sensor 206. In other words, the system manager 110 computes a “temperature delta” between the temperature measured by the first sensor 204 and the temperature measured by the second sensor 206. With reference to the illustrated example 200, for instance, the system manager 110 determines a difference between the temperature measured by the first sensor 204, e.g., of the portion 210, and the temperature measured by the second sensor 206, e.g., of the portion 212. It is to be appreciated that in variations the system manager 110 is configured to compute deltas between other types of sensor data (e.g., non-temperature data) measured by multiple sensors (e.g., a first sensor and a second sensor) in accordance with the described techniques.

In one or more implementations, the system manager 110 also determines a slope of the difference (e.g., a temperature gradient), and based on the slope, adds a correction to the raw sensor data, e.g., to the temperature measured by the first sensor 204 of the portion 210. In variations, the system manager 110 uses one or more of a variety of algorithms to compute temperature gradients over time between the various sensors 118, such as by using at least the thermal management algorithm 112 in one or more variations.

In at least one variation, the system manager 110 extrapolates the gradient to an opposite side of a sensor measuring the higher temperature, where the “opposite side” is opposite the sensor measuring the lower temperature. In the context of the illustrated example 200, for instance, the system manager 110 extrapolates a gradient (e.g., by continuing in a direction of the gradient) to an opposite side of the first sensor 204 from the second sensor 206. Based on this, the system manager 110 estimates or otherwise predicts the actual hottest temperature. In at least one variation, the system manager 110 also estimates or otherwise predicts a location of the hottest temperature. In one or more scenarios, the system manager 110 simply uses this predicted temperature as the hottest temperature. Alternatively or in addition, the system manager 110 corrects the raw sensor data by adding a correction to the hottest measured temperature to obtain the predicted temperature. This predicted or corrected temperature is referred to herein as the computationally corrected temperature.

Based on the computationally corrected temperature and the thermal management algorithm 112 as adjusted (e.g., based on user input and/or as specified by an application), the system manager 110 manages or adjusts settings of the system 100, such as by managing or adjusting power, frequency, timings, etc. of the component 202 and/or other components of the system 100. In one or more implementations, the system manager 110 also determines a location of the thermal hotspot 208 based on the temperature gradients between various combinations of two or more of the sensors 118, e.g., by extrapolating the gradients. In one or more implementations, the system manager 110 determines a location of one or more thermal hotspots on a same piece of silicon, e.g., a same hardware die. Alternatively or in addition, the system manager 110 determines a location of one or more thermal hotspots for a three-dimensional or 3D structure or component, such as between different die in a stacked part, e.g., Vcache or a stacked memory like DRAM. Thus, in one or more variations, the system manager manages power, frequency, timings, etc. of the component 202 and/or other components of the system 100 based on locations and temperatures of predicted (or estimated) thermal hotspots.

Although thermal sensors are discussed above and below, it is to be appreciated that in variations, the system 100 includes additional or different types of sensors. In such variations, the system manager 110 is configured to determine differences between the data produced by such other types of sensors (e.g., using one or more algorithms), add a correction to the sensor data produced by at least one of the sensors, and manage one or more of the components based on the computationally corrected data rather than using the raw sensor data. For example, the system manager 110 manages the one or more components based on the computationally corrected data using the thermal management algorithm 112 as discussed above and below, e.g., the system manager 110 manages power utilized by the one or more components by adjusting one or more of voltage, frequency, and/or timings according to the thermal management algorithm 112.

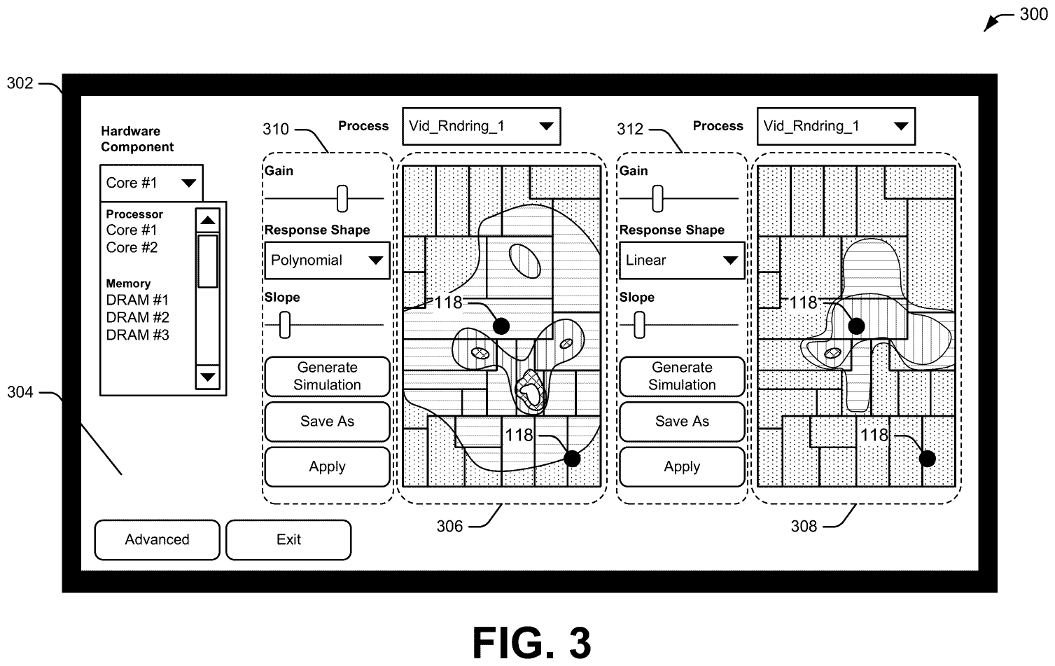

FIG. 3 depicts a non-limiting example 300 of a user interface in one or more implementations.

The example 300 includes a display device 302 outputting a user interface 304, which includes interactive interface elements for adjusting parameters of a thermal management algorithm. It is to be appreciated that user interfaces for adjusting one or more parameters of the thermal management algorithm 112 and/or for displaying visualizations of phenomena (e.g., temperatures) predicted in relation to one or more components of the system while operating with the thermal management algorithm 112 as adjusted are configurable in different ways without departing from the spirit or scope of the described techniques.

In this example 300, the user interface 304 presents a plurality of visualizations of a component of the system 100, e.g., a core 106 of the processor 102. In particular, the example 300 includes a first visualization 306 and a second visualization 308. In variations, the user interface 304 presents fewer visualizations e.g., one visualization) or more visualizations (e.g., three or more). A number of visualizations presented by the user interface 304 is configurable (e.g., user selectable) in one or more variations. In this example 300, each visualization is presented with interactive interface elements that are operable to adjust one or more parameters of the thermal management algorithm 112. In particular, the first visualization 306 is presented with a first set of interactive interface elements 310, and the second visualization 308 is presented with a second set of interactive interface elements 312. It is to be appreciated that the user interface 304 is configurable to include interactive elements for adjusting a variety of parameters of the thermal management algorithm 112 without departing from the spirit or scope of the described techniques.

In this example 300 the first visualization 306 and the second visualization 308 both correspond to a same workload or process (e.g., “Vid_Rndring_1”). In this way, the user interface 304 displays how adjusting one or more parameters of the thermal management algorithm 112 is predicted to affect one or more phenomena relative to the component, such as how adjusting the parameters is predicted to affect temperatures of different portions of the component, e.g., of a particular core of the processor 102.

By way of example, the first set of interactive interface elements 310 specifies a first set of parameters for the thermal management algorithm 112 (and/or at least a first adjustment to the algorithm), and the second set of interactive interface elements 312 specifies a second set of parameters for the thermal management algorithm 112 (and/or at least a second adjustment to the algorithm). In at least one example, for instance, a user provides input via the user interface 304 in relation to one or more of the interactive interface elements to adjust respective parameters, e.g., in relation to the second set of interactive interface elements 312 to cause the second set of parameters to differ from the first set of parameters. An application 116 (e.g., a thermal management application) and/or the system manager 110 generates a prediction of one or more phenomena at the component as one or more workloads or processes are performed by the system. In one or more implementations, the generated prediction is a snapshot, such as a snapshot that corresponds to a point in time when the workload or process causes the component to be exposed to the most extreme (e.g., maximum) phenomena, such as when the component is exposed to the hottest temperatures due to the workload or process, as simulated with the parameters as adjusted according to the interactive interface elements. Alternatively or in addition, the generated prediction is an animation or visualization of the phenomena over time, such that a change in the phenomena is predicted and displayed for a window of time that corresponds to a simulated execution of the workload or process with the parameters as adjusted according to the interactive interface elements.

In accordance with the described techniques, the first visualization 306 and the second visualization 308 include indications of a plurality of the sensors 118 that sense one or more conditions of the visualized components. Additionally, the visualizations include indications of one or more phenomena (e.g., temperatures), such as those determined based on the conditions detected by the sensors 118 and by using a gradient as discussed above and below. Like the example depicted in FIG. 2, the described techniques determine an actual maximum or minimum of a phenomenon and its location based on gradient. In addition to indicating how adjusting the parameters of the thermal management algorithm 112 affects one or more phenomena that occur in relation to a component, the visualizations presented by the user interface 304 also indicate which portions of a component are affected by parameter adjustments in connection with performing a particular workload or process.

In one or more implementations, the user interface 304 also includes interactive interface elements that are operable to select which component of the system is displayed and/or to select which workloads or processes in relation to which the visualizations are generated (e.g., a different workload or process can be selected for different visualizations). In at least one variation, the user interface 304 includes an interface element to cause generation of a simulation or prediction of one or more phenomena as the workload process is performed, e.g., such that the simulation or prediction is not generated until the interactive interface element is selected. Waiting to generate a prediction or a simulation until such an interactive element is selected conserves computing resources in relation to generating predictions and/or simulations each time a user provides input to adjust a parameter of the thermal management algorithm 112. Additionally or alternatively, the user interface 304 includes one or more interactive elements for saving parameters as specified using the interactive interface elements, such as to save the parameters for use with a particular workload or process. Alternatively or in addition, the user interface 304 includes one or more interactive element to apply the parameters to the thermal management algorithm 112 when the element is selected, such that the thermal management algorithm 112 is adjusted in real time based on the parameters as specified in the user interface 304 and the thermal management algorithm 112 is subsequently executed using the adjusted parameters.

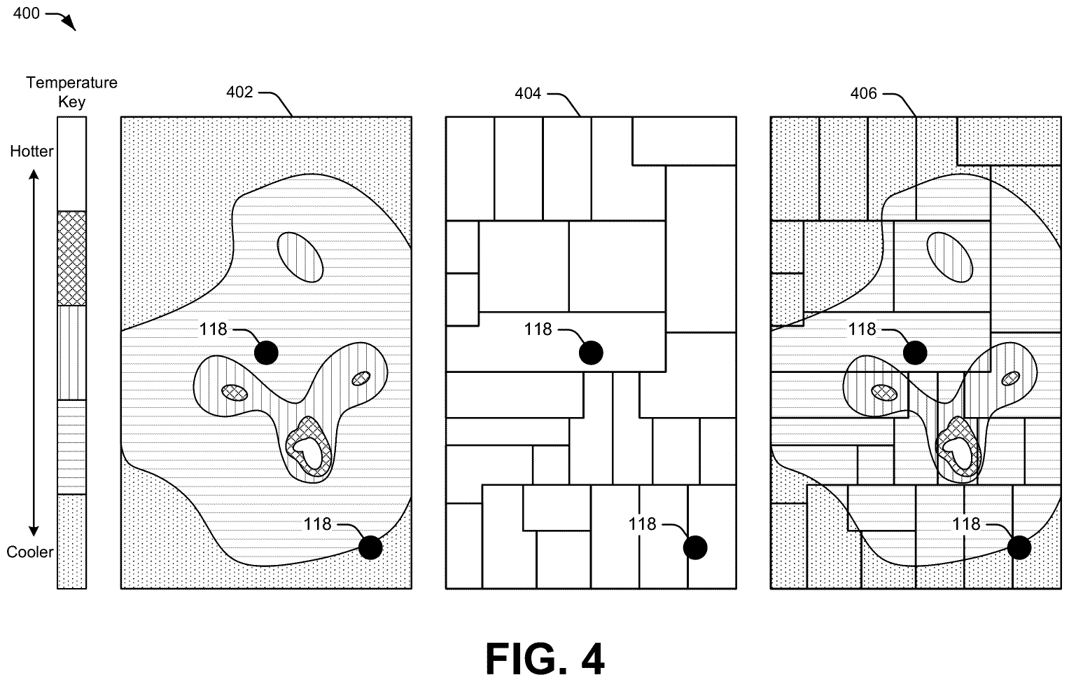

In the context of how layers of a visualization indicate which logic blocks (e.g., intellectual property (IP) blocks of a component (e.g., a core)) are affected by parameter adjustments, consider the following example depicted in FIG. 4.

FIG. 4 depicts a non-limiting example 400 of layers that are displayable as part of a visualization for a component in a user interface for adjustable thermal management.

The illustrated example 400 includes a first layer 402, a second layer 404, and a combined view 406 that integrates the first layer and the second layer, e.g., the first layer overlays the second layer or vice versa. The first layer 402 depicts an indication of a condition (e.g., temperature) at across a component (e.g., a core) of the system 100. In this example 400, the first layer 402 is configured as a heat map or topographical representation of the condition across the component. In variations, conditions are indicated differently in in visualizations without departing from the spirit or scope of the described techniques. The second layer 404 depicts a “floorplan” of the component. For example, the lines depicted in the second layer 404 indicate logic blocks (e.g., IP blocks) of a component and a portion of the component occupied by individual logic blocks. When the component corresponds to a core, for instance, examples of such logic blocks include but are not limited to data cache, scheduler, and floating point, to name just a few. A floorplan indicative of logic blocks of a component is capable of indicating a variety of logic blocks in accordance with the described techniques. In one or more implementations, the logic blocks are labeled in user interfaces with an identifier, e.g., with text. Alternatively or in addition, an identifier of a logic block is displayed responsive to a user interaction in relation to a logic block, e.g., hovering over it, tapping it, etc.

In the combined view 406 the first layer 402 and the second layer 404 are integrated such that a relationship between the condition and the logic blocks is presented. The system is thus capable of presenting an indication of one or more thermal hotspots (or other condition maxima or minima) over the corresponding logic blocks. In this way a user can see which logic blocks are causing hotspots and/or subject to more extreme thermal conditions. This information can help inform a user how to adjust one or more parameters of the thermal management algorithm 112, e.g., via the interactive user interface elements of the user interface 304, and then cause the system manager 110 to adjust operation of the component (e.g., by changing voltage, frequency, and/or timings) based on the thermal management algorithm 112 as adjusted.

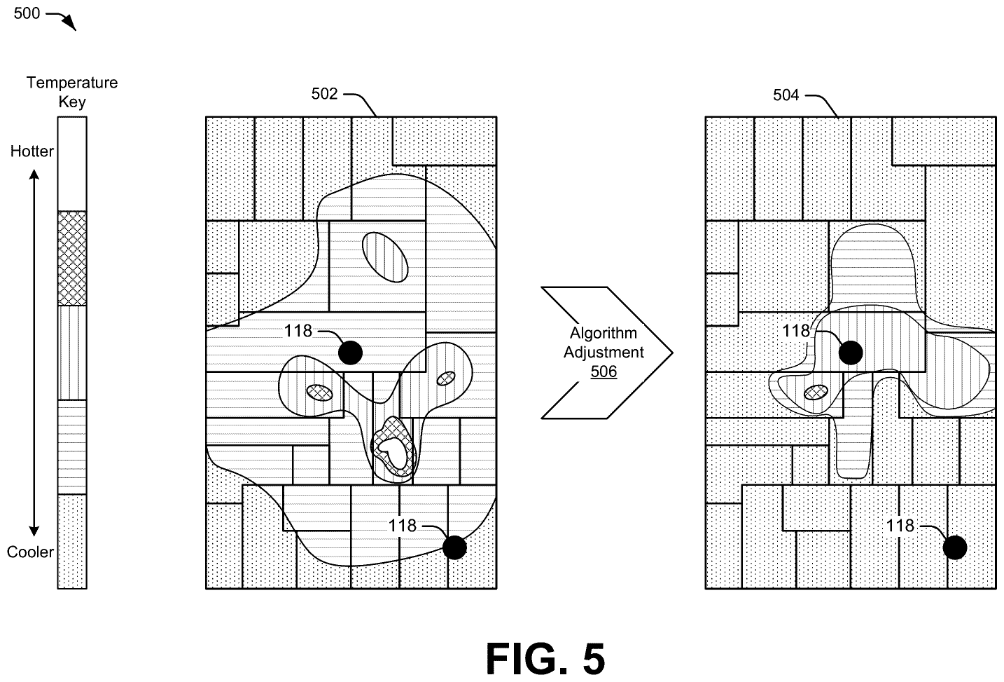

FIG. 5 depicts a non-limiting example 500 of a visualization of a component that changes based on a prediction associated with adjusting one or more parameters for thermal management.

The illustrated example 500 includes a first instance of a visualization 502 and a second instance of a visualization 504, e.g., the visualization at a first time and at a second time. In this example 500, the first instance of the visualization 502 and the second instance of the visualization 504 correspond to a same workload or process. However, the first instance of the visualization 502 corresponds to a first set of parameters for the thermal management algorithm 112 and the second instance of the visualization 504 corresponds to a second set of parameters for the thermal management algorithm 112, which includes at least one different parameter (e.g., a changed, additional, or removed parameter) from the first set. In particular, the illustrated example 500 depicts a difference in a visualization when an algorithm adjustment 506 is received. In at least one scenario, for instance, the first instance of the visualization 502 is generated and displayed at a first time based on a first set of parameters of the thermal management algorithm 112. Subsequently, the algorithm adjustment 506 is received to adjust at least one parameter of the thermal management algorithm 112, e.g., based on user input via a user interface, resulting in a second set of parameters. The visualization is updated based on the second set of parameters of the thermal management algorithm 112, and the second instance of the visualization 504 is displayed at a second time. In this way, the system shows a user how changing one or more parameters is predicted to affect a condition across a component and which logic blocks of the component are affected and/or potentially at risk for experiencing one or more adverse effects and/or conditions.

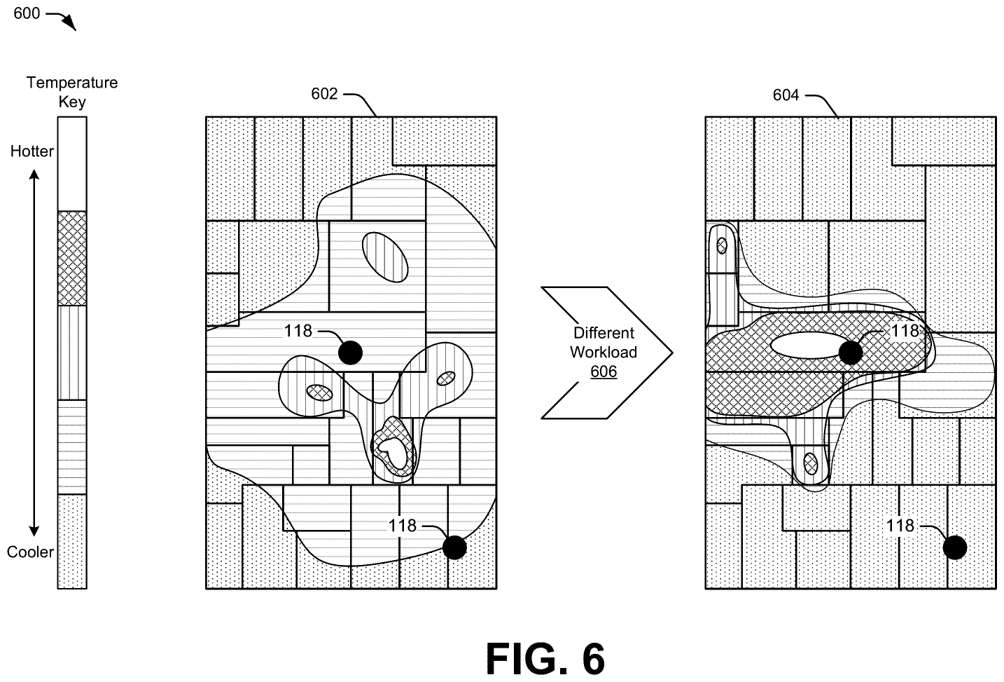

FIG. 6 depicts a non-limiting example 600 of a visualization of a component that changes based on a prediction associated with executing a different workload and managing power using adjustable parameters for thermal management.

The illustrated example 600 also includes a first instance of a visualization 602 and a second instance of a visualization 604, e.g., the visualization at a first time and at a second time. In this example 600, the first instance of the visualization 602 and the second instance of the visualization 604 correspond to a different workload or process, such that the first instance of the visualization 602 corresponds to first workload or process and the second instance of the visualization 604 corresponds to a second workload or process that is different from the first workload or process. Notably, though, the visualizations are generated and displayed in this example based on the thermal management algorithm 112 having a same set of parameters for both instances of the visualization. Thus, the illustrated example 500 depicts a difference in a visualization when generated and displayed for a different workload 606. In at least one scenario, for instance, the first instance of the visualization 602 is generated and displayed at a first time based on a set of parameters of the thermal management algorithm 112 and a first workload or process. Subsequently, an input to generate the visualization for a different workload 606 is received, e.g., based on user input via a user interface. The visualization is updated based on a second workload and the set of parameters of the thermal management algorithm 112 (e.g., the same set of parameters as for the first visualization), and the second instance of the visualization 604 is displayed at a second time. In this way, the system shows a user how different workloads or processes are predicted to affect a condition across a component and which logic blocks of the component are affected and/or potentially at risk for experiencing one or more adverse effects and/or conditions based on the different workloads.

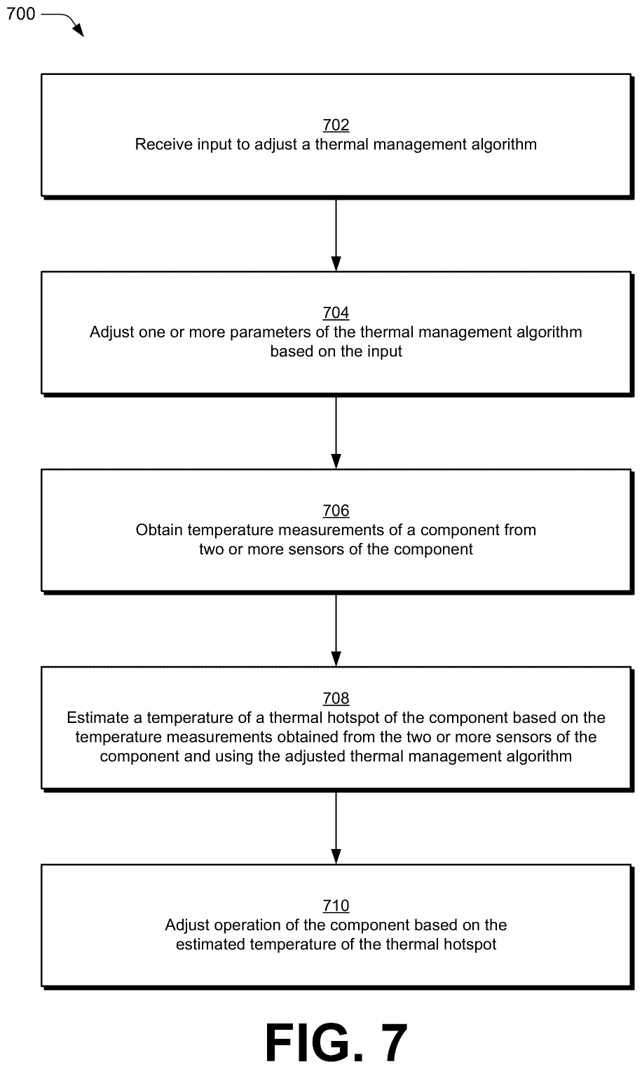

FIG. 7 depicts a procedure in an example 700 implementation of adjustable thermal management.

Input to adjust a thermal management algorithm is received (block 702), and one or more parameters of the thermal management algorithm are adjusted based on the input (block 704). In one or more implementations, the user interface 122 is output by an application 116, such as a thermal management application. For example, the user interface 122 is displayed and or made accessible via a voice-based user interface. The user interface 122 receives the input 124 (e.g., via one or more interactive interface elements) to adjust one or more of parameters, such as by adding or removing one or more gain terms, adjusting deltas, adjusting a slope associated with the algorithm (e.g., linear, polynomial, etc.), adjusting the presence or absence of one or more filters, adjusting parameters of the filters, adjusting an amount of history (e.g., of measurements) to store and use to determine system responses (e.g., a point in time versus a first interval of time versus a second, longer interval of time), and so forth. Thus, in one or more variations, the input 124 to adjust the thermal management algorithm 112 is user input received via the user interface 122.

Alternatively or additionally, the input 124 is received from one or more applications 116 to adjust the thermal management algorithm 112. In one or more variations, for instance, an application 116 includes configuration settings which specify parameters to which to adjust the thermal management algorithm 112 for optimal performance of the application 116. Alternatively or in addition, an application 116 includes configuration settings which specify parameters to which to adjust the thermal management algorithm 112 for optimal performance of particular workloads, e.g., on a workload-by-workload basis and/or on a type of workload basis. In one example, for instance, a computer game application includes settings that specify a first set of parameters to which to adjust the thermal management algorithm 112 for graphics rendering and a second set of parameters at which to adjust the thermal management algorithm 112 for game physics. In scenarios where an application 116 provides the input 124 to adjust the thermal management algorithm 112, for example, the application 116 provides an instruction to the processor 102 to adjust the thermal management algorithm 112.

Temperature measurements of a component are obtained from two or more sensors of the component (block 706). By way of example, the system manager 110 obtains temperature measurements from two or more sensors 118.

A temperature of a thermal hotspot of the component is estimated based on the temperature measurements obtained from the two or more sensors of the component and using the adjusted thermal management algorithm (block 708). By way of example, the system manager 110 estimates a temperature of a thermal hotspot of the component based on the data produced by two or more sensors 118 and using the adjusted thermal management algorithm 112. In at least one variation, the system manager 110 determines temperature deltas between two or more of the sensors 118 using one or more algorithms that account for temperature deltas, e.g., the thermal management algorithm 112 and/or a different, additional algorithm. For example, the system manager 110 determines a slope of a temperature delta (e.g., a difference) between at least two of the sensors 118. By way of example, two or more of the sensors 118 measure differences (e.g., in temperature) within a particular core, between different cores on a same piece of silicon, between different pieces of silicon within a package, e.g., a component with a stacked configuration such as Vcache and/or stacked DRAM. In at least one variation, the system 100 includes sensors 118 disposed between components, such as between different dies of a component having a stacked configuration.

Operation of the component is adjusted based on the estimated temperature of the thermal hotspot (block 710). By way of example, the system manager 110 computes one or more adjustments to make to operation of one or more components using the estimated temperature of the thermal hot spot. Examples of such adjustments include, for instance, throttling one or more of voltage, frequency, timings, and so on, for one or more components of the system 100.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the memory 104, the controller 108, and the core 106) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a processor;
a first thermal sensor positioned at a first portion of the processor;
a second thermal sensor positioned at a second portion of the processor; and
a system manager, the system manager configured to:
obtain a first temperature measurement from the first thermal sensor and a second temperature measurement from the second thermal sensor;
estimate, using one or more adjustable parameters, a temperature of a thermal hotspot on the processor based on the first temperature measurement and the second temperature measurement; and
adjust one or more settings of the processor based on the estimated temperature of the thermal hotspot.

2. The system of claim 1, wherein the system manager is further configured to estimate a location of the thermal hotspot.

3. The system of claim 1, wherein the estimated temperature of the thermal hotspot is higher than the first temperature measurement and the second temperature measurement.

4. The system of claim 1, wherein the thermal hotspot is located at a different portion of the processor from where the first thermal sensor and the second thermal sensor are disposed.

5. The system of claim 1, wherein the system manager is further configured to:
expose a user interface for adjusting the one or more adjustable parameters used to estimate the thermal hotspot;
receive, via the user interface, user input to adjust the one or more adjustable parameters; and
save the adjusted parameters for subsequent use to estimate temperatures of thermal hotspots on the processor.

6. The system of claim 1, wherein the one or more adjustable parameters comprise at least one of a term, weight, degree, constant, or value of a thermal management algorithm.

7. The system of claim 1, wherein the one or more adjustable parameters are adjustable by:
adding or removing one or more gain terms from the parameters;
adjusting one or more deltas to maintain between the first thermal sensor and the second thermal sensor;
adjusting a slope associated with estimating temperatures of thermal hotspot on the processor based on temperature measurements produced by the first thermal sensor and the second thermal sensor;
adjusting a presence or absence of one or more filters in the parameters; or
adjusting parameters of the one or more filters.

8. The system of claim 1, wherein the system manager is further configured to:
receive, from an application, input to adjust the one or more adjustable parameters; and
save the adjusted parameters for subsequent use to estimate temperatures of thermal hotspots on the processor.

9. The system of claim 1, wherein the system manager is configured to estimate the temperature of the thermal hotspot at a first interval of time using a first set of parameters, and wherein the system manager is configured to estimate an additional temperature of the thermal hotspot at a second interval of time using a second set of parameters, the second set of parameters having been adjusted from the first set of parameters.

10. The system of claim 1, wherein the system manager is configured to predict the temperature of the thermal hotspot by:
determining a temperature delta between the first temperature measurement and the second temperature measurement;
determining a slope of the temperature delta; and
predicting the temperature of the thermal hotspot based on the slope of the temperature delta.

11. A method comprising:
receiving input to adjust one or more parameters used to control thermal conditions of a component;
obtaining temperature measurements of the component from two or more sensors of the component;
estimating a temperature of a thermal hotspot of the component based on the temperature measurements obtained from the two or more sensors of the component and using the adjusted parameters; and
adjusting operation of the component based on the estimated temperature of the thermal hotspot.

12. The method of claim 11, wherein the receiving input further comprises:
exposing a user interface for adjusting the one or more parameters; and
receiving, via the user interface, the input to adjust the one or more parameters.

13. The method of claim 11, wherein the one or more parameters comprise at least one of a term, weight, degree, constant, or value of a thermal management algorithm.

14. The method of claim 11, wherein the adjusting comprises one or more of:
adding or removing one or more gain terms from the parameters;
adjusting one or more deltas to maintain between the two or more sensors of the component;
adjusting a slope associated with estimating temperatures of thermal hotspots of the component based on temperature measurements produced by the two or more sensors;
adjusting a presence or absence of one or more filters in the parameters; or
adjusting parameters of the one or more filters.

15. The method of claim 11, wherein the receiving input further comprises receiving, from an application, the input to adjust the one or more parameters.

16. The method of claim 11, wherein the estimating further comprises estimating the temperature of the thermal hotspot at a first interval of time using a first set of parameters.

17. The method of claim 16, further comprising estimating an additional temperature of the thermal hotspot at a second interval of time using a second set of parameters, wherein the second set of parameters is different from the first set of parameters.

18. The method of claim 11, wherein the thermal hotspot is located at a different portion of the component from where the two or more sensors are disposed.

19. The method of claim 11, wherein the estimated temperature of the thermal hotspot is higher than the obtained temperature measurements.

20. A device comprising:
a stacked memory having a plurality of memory dies; and
a system manager configured to:
obtain temperature measurements from thermal sensors associated with different memory dies of the stacked memory;
predict a hotspot of the stacked memory based on a difference between the temperature measurements from the thermal sensors using one or more adjustable parameters; and
adjust one or more settings of the stacked memory based on the predicted hotspot.
